(19) United States
(12) Patent Application Publication
(10) Pub. No.: US 2006/0081586 A1
(43) Pub. Date: Apr. 20, 2006

(54) Electrical device with a safety switch

(76) Inventor: George Stephen Ramsay, Newport Beach (AU)

Correspondence Address: BROOKS KUSHMAN P.C., 1000 TOWN CENTER, TWENTY-SECOND FLOOR, SOUTHFIELD, MI, 48075, US

(21) Appl. No.: 10/540,288

(22) PCT Filed: Dec. 16, 2003
(86) PCT No.: PCT/AU03/01673

§ 371 Date: Jun. 20, 2005

(30) Foreign Application Priority Data
Dec. 18, 2002 (AU) 20029553412

(51) Int. Cl. H05B 1/00; H05B 3/42

(52) U.S. Cl. 219/235

(57) ABSTRACT

A hand held electrical appliance operable from an AC mains supply. The appliance having a first switch connected in series with the mains supply, and a second switch operatively associated with the first switch and connected in series therewith. The appliance is only operable when both the switches are operated. The appliance includes a low voltage transformer, and a relay connected to the output of the transformer via the second switch and energisable thereby. The switchable contacts of the relay being in series with the first switch.

### TECHNICAL FIELD

The present invention relates to a electrical device with a safety switch and more particularly for a hand held hair dryer with a safety switch.

### BACKGROUND

Hand held electrical appliances are quite common in households. There are many types which generally fall into three categories, health and beauty, kitchen, and hand held electric tools. Health and beauty hand held electrical devices include electric hairdryers, curling irons, electric razors; kitchen devices generally include mixers, blenders, coffee makers, etc; while hand held electric tools include drills, hedge clippers, hand held saws and the like.

A problem associated with these generally inexpensive electrical hand held devices is that they can present a danger to the user when used near wet areas such as sinks, tubs and swimming pools in and around the home. The hand held electric hairdryer due to its inexpensive nature and its commonplace use in a bathroom presents a danger in the form of electrocution when the device is misused or accidentally immersed into water. Such hairdryers present a high risk to children.

A number of safety devices are known which interrupt electrical feed to an electrical appliance such as a hairdryer when it is immersed in water. Two known devices are described in U.S. Pat. No. 4,734,822 (GILARDONI et al) and U.S. Pat. No. 4,951,169 (MORSE). Such safety devices work on the principle of interrupting the AC mains power supply upon immersion of the device in water.

The present invention seeks to provide an improved electrical device or appliance which is fitted with a safety switch.

### SUMMARY OF INVENTION

In accordance with a first aspect the present invention consists in a hand held electrical appliance operable from an AC mains supply, said appliance having a first switch connected in series with said mains supply, and a second switch operatively associated with said first switch and connected in series therewith, whereby said appliance is only operable when both said switches are operated, and said appliance includes a low voltage transformer, a relay connected to the output of said transformer via said second switch and energisable thereby, the switchable contacts of said relay being in series with said first switch.

Preferably said first switch and said second switch are operatively actuated by trigger mechanisms that are in close proximity to each other and both operable by the single hand of a user.

Preferably said output of said transformer is a direct current.

Preferably said trigger mechanism of the second switch is biased towards an off configuration.

Preferably said transformer and relay are housed within a plug pack.

Preferably a first light indicator is provided on said plug pack to indicate when the second switch is energised.

Preferably a second light indicator is provided on said plug pack to indicate when mains power supply is being delivered via said second switch.

### BRIEF DESCRIPTION OF THE DRAWINGS

FIG. 1 is a schematic diagram of a hand held electric hairdryer comprising a safety switch in accordance with a first embodiment of the present invention.

FIG. 2 is a circuit diagram of the electric hairdryer shown in FIG. 1.

### MODE OF CARRYING OUT THE INVETION

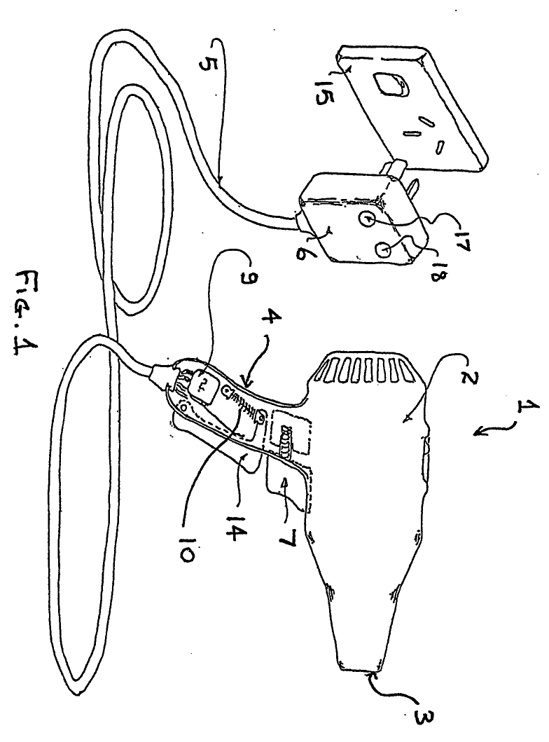

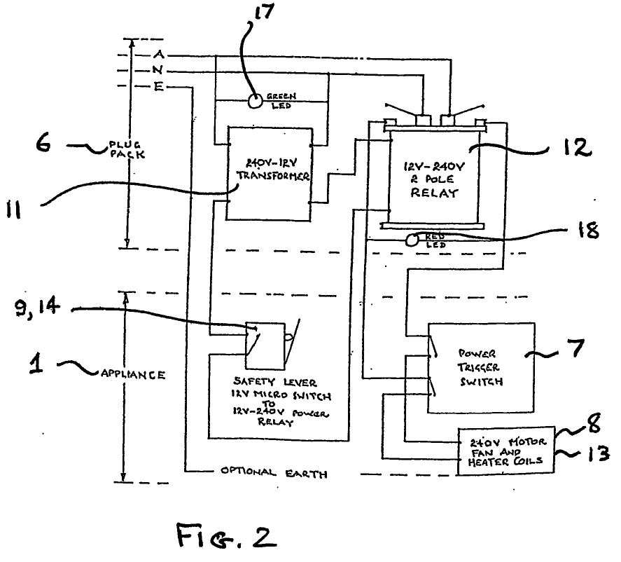

FIGS. 1 and 2 depict an electric hairdryer in accordance with a first embodiment of the present invention. Electric hairdryer 1 has a body 2, at the leading end of which is a hot air outlet 3 and a handle 4. A power cord 5 extends from body 2 and handle 4 rearwardly to a plug pack 6 adapted to be plugged into a standard AC mains supply outlet 15.

Handle 4 comprises a trigger switch 7, which may be a conventional three speed or variable speed switch, for operating fan motor 8 and heater coils 13.

Handle 4 also comprises a safety micro switch 9 operatively activated by a safety lever 14 in close proximity to trigger switch 7. Safety lever 14 and switch 9 are biased to the “off position” by a spring mechanism 10.

Plug pack 6 comprises a transformer 11 which reduces a typical AC mains supply, say 110V-240V, to a substantially lower DC voltage of say, in this preferred embodiment, 12 volts. Transformer 11 is operatively connected to a two pole relay 12 which is also operatively connected to trigger switch 7 and safety switch 9. The trigger switch 7 is connected in series with the AC mains supply, and safety switch 9 is in series with trigger switch 7 via relay 12.

In use, when plug pack 6 is electrically connected to a AC mains supply outlet 15, transformer 11 delivers 12 volt DC supply to safety switch 9 for its operation. In use, in order for the conventional trigger switch 7 to receive and deliver the AC mains voltage to the fan motor 8 and heater coils 13, the safety switch 9 must be in the “on position”. As soon as safety switch 9 is released, the AC mains supply will be interrupted even if the conventional trigger switch 7 has been left in the “on position”. As such, in order for a user to operate electric hairdryer 1, the user must depress safety lever 14 (safety switch 9) for mains power to flow to trigger switch 7.

Plug pack 6 also comprises a green light indicator 17 and a red light indicator 18. The green light indicator 17 lights up when AC mains power is being delivered to the plug pack 6 from the AC mains outlet 15, and delivers 12V DC current to safety switch 9. This will visually indicate to the user that the device is in a “safe” standby mode. The red light indicator 18 will only light up when the safety lever 14 (switch 9) is depressed, thereby indicating that the AC mains power supply is being delivered to trigger switch 7 to operate motor fan 8 and heater coils 13.

As such, if electric hairdryer 1 is accidentally dropped within a sink or tub or water or other moist environment, the AC mains power supply cannot cause injury or electrocution by short circuit, as the AC mains supply cannot be delivered to the hairdryer 1 without safety lever 14 being depressed. This adds a level of safety to the hairdryer 1, as the 12V DC voltage supply being delivered to safety micro switch 9 will not electrocute or seriously harm the user, if the dryer 1 is immersed in water. Immersion of the 12V micro safety switch in water will not result in a short circuit.

In order for safety switch 9 and trigger switch 7 to be actuated simultaneously, the trigger mechanisms are in close proximity to each other on handle 4, thereby allowing them to be actuated by the single hand of a user.

Preferably the size and shape of safety lever 14 and the biased force provided by spring mechanism 10, is such that an adult would not have difficulty in operating dryer 1, however it would pose a difficult exercise for a young child to operate. This adds another level of safety.

It should be understood that whilst the abovementioned embodiment is described with reference to a dryer 1, the safety switch arrangement may be used on other hand held electrical appliances and tools.

The term “comprising” (and its grammatical variations) as used herein is used in the inclusive sense of “having” or “including” and not in the exclusive sense of “consisting only of”.

1. A hand held electrical appliance operable from an AC mains supply, said appliance having a first switch connected in series with said mains supply, and a second switch operatively associated with said first switch and connected in series therewith, whereby said appliance is only operable when both said switches are operated, and said appliance includes a low voltage transformer, a relay connected to the output of said transformer via said second switch and energisable thereby, the switchable contacts of said relay being in series with said first switch.

2. The appliance as claimed in claim 1, wherein said first switch and said second switch are operatively actuated by trigger mechanisms that are in close proximity to each other and both operable by the single hand of a user.

3. The appliance as claimed in claim 1, wherein said output of said transformer is a direct current.

4. The appliance as claimed in claim 1, wherein the trigger mechanism of the second switch is biased towards an off position.

5. The appliance as claimed in claim 1, wherein said transformer and relay are housed within a plug pack.

6. The appliance as claimed in claim 5, wherein a first light indicator is provided on said plug pack to indicate when said second switch is energised.

7. The appliance as claimed in claim 5, wherein a second light indicator is provided on said plug pack to indicate when mains power supply is being delivered via said second switch.
